(19) United States
(12) Patent Application Publication
(10) Pub. No.: US 2007/0280065 A1
(43) Pub. Date: Dec. 6, 2007

(54) OPTICAL INFORMATION RECORDING/REPRODUCTION APPARATUS

(75) Inventor: Takashi Fukuhara, Tokyo (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/752,688

(22) Filed: May 23, 2007

(30) Foreign Application Priority Data
Jun. 5, 2006 (JP) 2006-156066

(51) Int. Cl. G11B 7/00

(52) U.S. Cl. 369/44.29; 369/112.23

(57) ABSTRACT

An optical information recording/reproduction apparatus capable of performing accurate tracking control without depending on a radial runout of an optical disk is provided. Specifically, light reflected on an optical disk is detected by a first photodetector and a tracking error signal is detected from an output thereof. Also, return light reflected on an end surface of an SIL which is opposed to the optical disk is detected by a second photodetector, and a position signal of an optical head portion in a tracking direction is detected from on an output thereof. Further, the tracking error signal is corrected based on the position signal to remove an offset, thereby performing accurate tracking control.

### BACKGROUND OF THE INVENTION

1. Field of the Invention

The present invention relates to an optical information recording/reproduction apparatus for performing recording or reproduction of information on an optical information recording medium such as an optical disk, and specifically to a technique for performing servo control using a solid immersion lens (hereinafter abbreviated as “SIL”) and an objective lens.

2. Description of the Related Art

Up to now, in order to increase a recording density of an optical disk, it is required to reduce a diameter of a light spot on a recording surface of the optical disk by shortening a wavelength of light used for recording/reproduction and by increasing a numerical aperture (NA) of an objective lens.

Therefore, in order to obtain NA of 1 or more even in the air, attempts have been made in which a front lens is disposed close to the recording surface such that a distance between the front lens and the recording surface becomes equal to or shorter than a fraction (for example, ½) of a recording wavelength, thereby constructing a so-called SIL. This technique is described in detail by, for example, “Near Field Recording on First-Surface Write-Once Media with a NA=1.9 Solid Immersion Lens”, Japan Journal Applied Physics, Volume 44 (2005), pp. 3564-3567.

In addition, the technique is described in detail by, for example, “Near Field Read-Out of First-Surface Disk with NA=1.9 and a Proposal for a Cover-Layer Incident, Dual-Layer Near Field System”, Optical Data Storage, 2004, Proceedings of SPIE, Volume 5380 (2004).

FIG. 5 illustrates a structure of an optical pickup for near field recording in the prior art (Japan Journal Applied Physics, Volume 44 (2005), pp. 3564-3567). A light beam emitted from a semiconductor laser 1 having a wavelength of 405 nm is converted into a parallel light beam by a collimator lens 2 and incident on a beam shaping prism 3, thereby obtaining an isotropical light amount distribution.

Further, a light beam transmitted through a non-polarizing beam splitter (NBS) 4 and a polarizing beam splitter (PBS) 7 passes through a ¼ wavelength plate (QWP) 8 to be converted from linearly polarized light into circularly polarized light. A photodetector (LPC-PD) 6 for receiving a light beam reflected by the non-polarizing beam splitter (NBS) 4 to control the emission power of the semiconductor laser 1 is provided.

A light beam passing through the ¼ wavelength plate (QWP) 8 is incident on an expander lens 9. The beam expander 9 is used to correct spherical aberration caused in an objective lens or an SIL as described later and constructed such that a distance between two lenses of the beam expander can be controlled corresponding to the spherical aberration.

The light beam from the expander lens 9 is incident on an objective lens 11 of an optical head portion 10. The optical head portion 10 includes the objective lens 11 and an SIL 12. The objective lens 11 and the SIL 12 are mounted on a biaxial actuator (not shown) for integrally driving the two lenses in a focus direction and a tracking direction.

Here, only when a distance between a bottom surface of the SIL 12 and an optical disk 13 is equal to or shorter than a fraction of 405 nm which is a light source wavelength, for example, when the distance is a short distance of 100 nm or less, a light beam from the bottom surface of the SIL 12 acts on a recording surface as evanescent light. Therefore, it is possible to realize recording/reproduction with a light spot diameter of NAeff. In order to maintain this distance, gap servo control described later is employed. Referring to FIG. 5 again, an optical system on a return optical path will be described.

The light beam reflected on the optical disk 13 becomes reversed circularly polarized light and is incident on the SIL 12 and the objective lens 11 to be converted into a parallel light beam again. Then, the light beam passes through the expander lens 9 and the ¼ wavelength plate (QWP) 8 to be converted into linearly polarized light in a direction orthogonal to the direction of the polarized light which goes to the optical disk 13 and a resultant light beam is reflected by the polarizing beam splitter (PBS) 7.

The reflected light beam is incident on a ½ wavelength plate (HWP) 14 and a polarizing plane thereof is rotated by 45°. An S-polarized light component of the light beam whose polarizing plane is rotated 45° by the ½ wavelength plate (HWP) 14 is reflected by a polarizing beam splitter (PBS) 15 and focused on a photodetector (PD1) 17 through a lens 16. Therefore, an RF output 18 including information on the optical disk 13 is generated.

On the other hand, a P-polarized light component of the light beam whose polarizing plane is rotated 45° by the ½ wavelength plate (HWP) 14 passes through the polarizing beam splitter (PBS) 15 and is reflected on a mirror 19. The reflected light beam is focused on a two-divided photodetector (PD2) 21 through a lens 20. A tracking error 22 is obtained from the output of the two-divided photodetector (PD2) 21 and input to a tracking control circuit 23.

On the other hand, a light beam of NAeff<1 which does not cause a total reflection, of the light beam reflected on the bottom surface of the SIL 12, is reflected as circularly polarized light reversed from that at the time of incidence similarly as in the case of the reflected light on the optical disk 13. In the case of a light beam of NAeff≧1 which causes total reflection, a phase difference δ expressed by the following expression is generated between a P-polarized light component and an S-polarized light component. Therefore, the light beam is shifted from circularly polarized light to become elliptically polarized light.

tan(δ/2)=cos θi×√(N2×sin 2θi−1)/(N×sin 2θi) Expression (1)

Therefore, after passing through the ¼ wavelength plate (QPW) 8, the light beam includes a polarized light component in the same direction as that of the polarized light which goes to the optical disk 13. The polarized light component passes through the polarizing beam splitter (PBS) 7 and is reflected by the non-polarizing beam splitter (NBS) 4. Then, the reflected light is focused on a photodetector (PD3) 25 through a lens 24.

A light amount of the light beam monotonically reduces as a distance between the bottom surface of the SIL 12 and the optical disk 13 shortens in a near field region. Therefore, the light beam can be used to generate a gap error signal 26. When a target threshold value is set in advance, a distance between the bottom surface of the SIL 12 and the optical disk 13 can be maintained at a desirable distance of 100 nm or less by the gap servo control.

The gap servo control is described in detail by Japan Journal Applied Physics, Volume 44 (2005), pp. 3564-3567 (Reference 1). The light beam is not modulated by recording information on the optical disk 13, so that a stable gap error signal can be obtained regardless of the presence or absence of the recording information.

A distance between the objective lens 11 and the SIL 12 is adjusted by a voice coil motor (not shown). The objective lens 11 is controlled in an optical axis direction to perform focus control.

As described above, the objective lens 11 and the SIL 12 are mounted on the biaxial actuator (not shown). The tracking control circuit 23 controls the biaxial actuator based on the tracking error signal 22 to control the objective lens 11 and the SIL 12 in the tracking direction, thereby performing tracking control.

A gap servo circuit (not shown) controls the biaxial actuator based on the gap error signal 26 to integrally control the objective lens 11 and the SIL 12 in the optical axis direction. Therefore, the gap servo control is performed so as to keep a distance between the SIL 12 and the optical disk 13 to a predetermined value.

In the conventional technique, when the optical head portion 10 is moved in a radius direction of the optical disk 13 by, for example, a radial runout of the optical disk 13, a beam spot simultaneously moves on the two-divided photodetector (PD2) 21, so that an offset is generated in the tracking error 22. Therefore, there is a problem in that the optical head portion 10 is shifted from an accurate position on an information track of the optical disk 13.

### SUMMARY OF THE INVENTION

An object of the present invention is to provide an optical information recording/reproduction apparatus capable of performing accurate tracking control without depending on a radial runout of an optical disk or the like.

A specific structure is as follows.

There is provided an optical information recording/reproduction apparatus for performing recording or reproduction of information, including: an optical head portion including an objective lens and a solid immersion lens; a laser light source, wherein recording or reproduction of information is performed by focusing a light beam from the laser light source on an information recording medium through the optical head portion; a first photodetector for detecting light reflection on the information recording medium, wherein a tracking error signal is generated from an output of the first photodetector; a second photodetector for detecting return light reflected on an end surface of the solid immersion lens which is opposed to the information recording medium, wherein a position signal of the optical head portion in a tracking direction is generated from an output of the second photodetector; and a circuit for correcting the tracking error signal based on the position signal.

Further features of the present invention will become apparent from the following description of exemplary embodiments with reference to the attached drawings.

### BRIEF DESCRIPTION OF THE DRAWINGS

FIG. 1 is a structural diagram illustrating an optical information recording/reproduction apparatus according to an embodiment of the present invention.

FIG. 2 is a diagram illustrating a photodetector (PD3) and a circuit for detecting a gap error signal and a head portion position signal based on an output of the photodetector.

FIG. 3 is an explanatory diagram illustrating a push-pull offset amount based on the movement of an optical head portion in a radius direction.

FIG. 4 is a diagram illustrating a relationship between a position of the optical head portion and an optical head portion position signal.

FIG. 5 is a structural diagram illustrating an optical information recording/reproduction apparatus for near field recording in a conventional example.

### DESCRIPTION OF THE EMBODIMENT

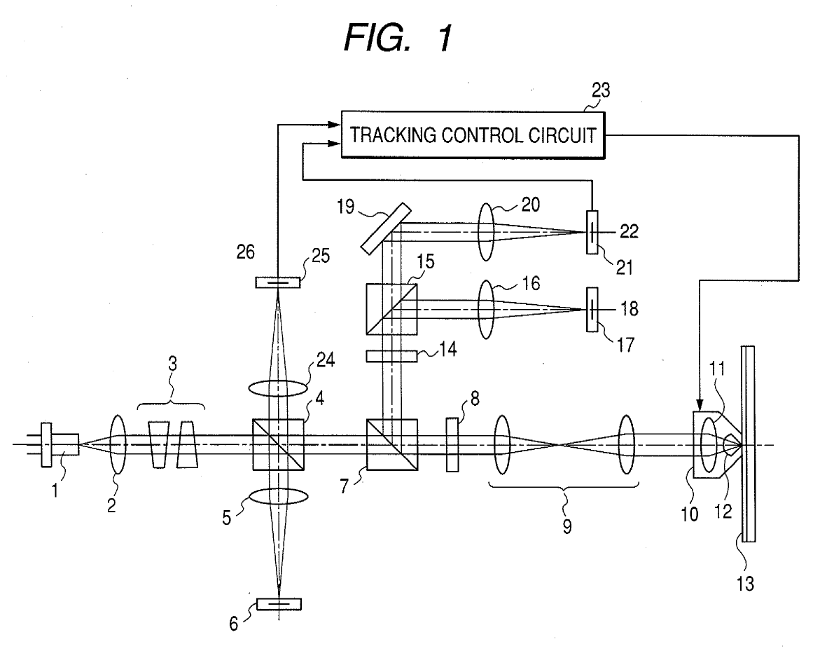

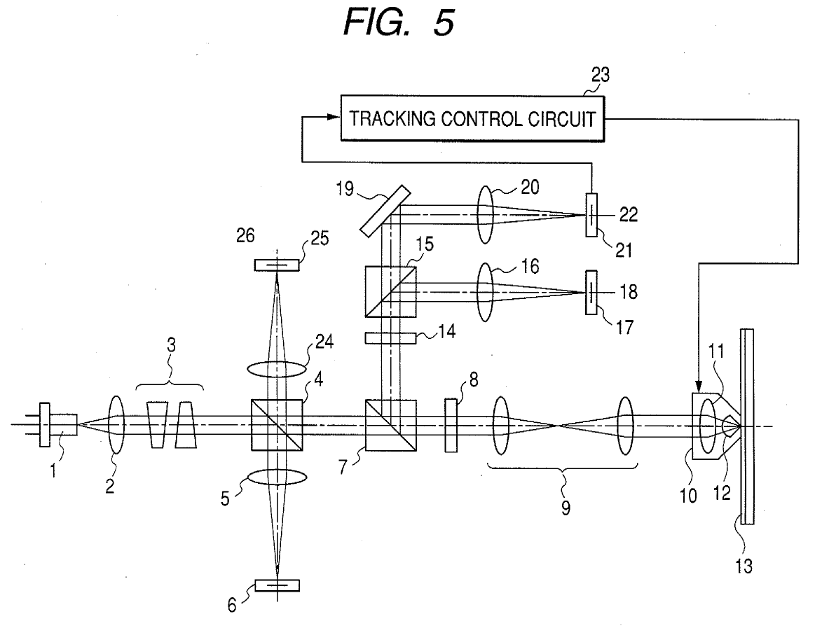

An exemplary embodiment for performing the present invention will be described in detail with reference to the attached drawings. FIG. 1 is a structural diagram illustrating one embodiment of an optical information recording/reproduction apparatus according to an embodiment of the present invention. In FIG. 1, the same portions as those in the conventional apparatus shown in FIG. 5 are expressed by the same reference numerals.

In FIG. 1, the structure of an optical pickup is mainly illustrated. Other circuits and mechanism including recording and reproduction circuits necessary to record or reproduce information on an optical disk and a controller for controlling the entire apparatus, and a spindle motor for rotating the optical disk are known and thus omitted here. A focus control circuit and a servo circuit such as a gap servo circuit are also omitted, except for a tracking control circuit.

The structure shown in FIG. 1 is different from the structure shown in FIG. 5 in that an optical head portion position signal is generated from on an output of a photodetector (PD3) 25 and input to a tracking control circuit 23. As described later, the tracking control circuit 23 corrects a tracking error signal using the optical head portion position signal to generate a tracking error signal with no offset.

In FIG. 1, a light beam which is emitted from a semiconductor laser 1 having a wavelength of 405 nm is converted into a parallel light beam by a collimator lens 2 and incident on a beam shaping prism 3, thereby obtaining an isotropical light amount distribution. A light beam which has transmitted through a non-polarizing beam splitter (NBS) 4 and a polarizing beam splitter (PBS) 7 passes through a ¼ wavelength plate (QWP) 8 to be converted from linearly polarized light into circularly polarized light.

A photodetector (LPC-PD) 6 for receiving a light beam reflected by the non-polarizing beam splitter (NBS) 4 to control the emission power of the semiconductor laser 1 is provided. A light beam passing through the ¼ wavelength plate (QWP) 8 is incident on an expander lens 9. The expander lens 9 is used to correct spherical aberration caused in an objective lens 11 or an SIL 12, and constructed such that a distance between two lenses of the beam expander can be controlled according to the spherical aberration.

The light beam from the expander lens 9 is incident on the objective lens 11 of an optical head portion 10. The optical head portion 10 includes the objective lens 11 and the SIL 12. As described above, the optical head portion 10 is mounted on a biaxial actuator (not shown) for integrally driving the two lenses in a focus direction and a tracking direction. The tracking control circuit 23 controls the biaxial actuator in the tracking direction to perform tracking control. A gap servo circuit (not shown) controls the biaxial actuator in an optical axis direction to perform gap servo control.

In this embodiment, the object lens 11 of NA=0.7 and the SIL 12 which is a hemispherical lens of NA=2 are combined with each other to set NAeff to 1.4.

Here, only when a distance between a bottom surface of the SIL 12 and the optical disk 13 is equal to or shorter than a fraction of 405 nm which is a light source wavelength, for example, when the distance is a short distance of 100 nm or less, a light beam from the bottom surface of the SIL 12 acts on a recording surface as evanescent light. Therefore, it is possible to realize recording or reproduction with a light spot diameter of NAeff. In order to maintain this distance, the gap servo control is employed.

The light beam reflected on the optical disk 13 becomes reversed circularly polarized light and is incident on the SIL 12 and the objective lens 11 to be converted into a parallel light beam again. Then, the light beam passes through the expander lens 9 and the ¼ wavelength plate (QWP) 8 to be converted into linearly polarized light in a direction orthogonal to the direction of the polarized light which goes to the optical disk 13, and a resultant light beam is reflected by the polarizing beam splitter (PBS) 7. The reflected light beam is incident on a ½ wavelength plate (HWP) 14 and a polarizing plane thereof is rotated by 45°.

An S-polarized light component of the light beam whose polarizing plane is rotated 45° by the ½ wavelength plate (HWP) 14 is reflected by a polarizing beam splitter (PBS) 15 and focused on a photodetector (PD1) 17 through a lens 16. Therefore, an RF output 18 including information on the optical disk 13 is generated.

On the other hand, a P-polarized light component of the light beam whose polarizing plane is rotated by 45° through the ½ wavelength plate (HWP) 14 passes through the polarizing beam splitter (PBS) 15 and is reflected on a mirror 19. The reflected light beam is focused on a two-divided photodetector (PD2) 21 through a lens 20. A tracking error 22 is obtained from an output of the two-divided photodetector (PD2) 21. The tracking error 22 is generated by, for example, a push-pull method.

A light beam of NAeff<1 which does not cause total reflection, of the light beam reflected on the bottom surface of the SIL 12, is reflected as circularly polarized light reversed from that at the time of incidence similarly as in the case of the reflected light on the optical disk 13. In the case of a light beam of NAeff≧1 which causes total reflection, a phase difference δ expressed by Expression (1) is generated between a P-polarized light component and an S-polarized light component. Therefore, the light beam is shifted from the circularly polarized light to become elliptically polarized light. After passing through the ¼ wavelength plate (QWP) 8, the light beam includes a polarized light component in the same direction as that of the polarized light which goes to the optical disk 13.

The polarized light component passes through the polarizing beam splitter (PBS) 7 and is reflected by the non-polarizing beam splitter (NBS) 4. Then, the reflected light is detected by a photodetector (PD3) 25 through a lens 24. A gap error signal 26 is obtained from on an output of the photodetector (PD3) 25.

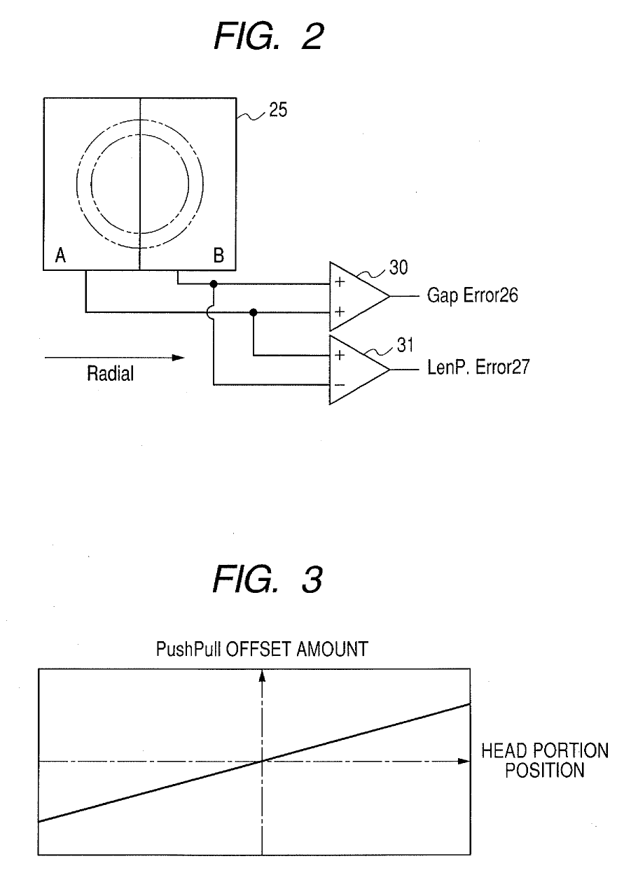

Here, in the present invention, as illustrated in FIG. 2, the two-divided photodetector (PD3) 25 on which a light beam passing through the lens 24 is incident is divided into two parts “A” and “B” in a direction parallel to a track direction. A light amount of the light beam incident on the two-divided photodetector (PD3) 25 monotonically reduces as a distance between the bottom surface of the SIL 12 and the optical disk 13 shortens in a near field region. Therefore, as illustrated in FIG. 2, a sum signal obtained by adding signals from the respective parts of the two-divided photodetector (PD3) 25 to each other by an adder 30 is obtained as the gap error signal 26. The gap servo circuit (not shown) performs gap servo control using the gap error signal.

When a target threshold value is set in advance, the gap servo circuit (not shown) controls the biaxial actuator (not shown) based on the gap error signal 26 to perform the gap servo control. Therefore, a distance between the bottom surface of the SIL 12 and the optical disk 13 can be maintained at a desirable distance of 100 nm or less by the gap servo control. The gap error signal 26 can be normalized using an output of the photodetector (LPC-PD) 6 for controlling the emission power of the semiconductor laser 1.

When the optical head portion 10 is moved in a radius direction by, for example, a radial runout of the optical disk 13, a light spot moves on the two-divided photodetector (PD2) 21, so that an offset is generated in the tracking error signal 22. FIG. 3 illustrates a relationship between an offset amount and a position of the optical head portion in such a case. The abscissa indicates an offset amount of the tracking error signal and the ordinate indicates the position of the optical head portion 10 in the tracking direction. The offset amount is changed according to the position of the optical head portion 10 in the tracking direction.

A light spot moves even on the two-part photodetector (PD3) 25. Therefore, as illustrated in FIG. 2, a position signal 27 for the optical head portion 10 is obtained by subtracting signals from the respective regions of the two-divided photodetector (PD3) 25 by a differential amplifier 31.

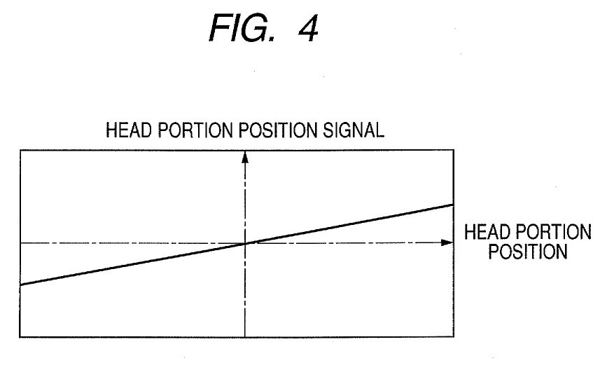

FIG. 4 illustrates a relationship between the position of the optical head portion and the optical head portion position signal. The abscissa indicates the position signal for the optical head portion 10 and the ordinate indicates the position of the optical head portion 10 in the tracking direction. As illustrated in FIG. 4, when the optical head portion 10 is shifted in the tracking direction, a level of the position signal 27 is changed according to the amount of shift. The position signal 27 can be expressed by the following expression.

(A−B)/(A+B)=LenP.error Expression (2)

In the tracking control circuit 23, calculation is performed for correcting the offset of the tracking error 22 by the optical head portion position signal 27, using a k-factor (coefficient). That is, calculation is performed for removing the offset from the tracking error, using the following expression. The coefficient k is adjusted so as to remove the offset from the tracking error signal.

Tracking Error TE=PushPull-k·LenP.error Expression (3)

In Expression (3), “PushPull” corresponds to the tracking error signal 22 and is obtained from an output of the two-divided photodetector (PD2) 21 by a conventionally known push-pull method. In addition, “k·LenP.error” corresponds to the position signal 27 of the optical head portion. The offset is removed from the tracking error signal by subtracting “k·LenP.error” from “PushPull”.

The tracking control circuit 23 performs the tracking control using the corrected tracking error signal. In this case, as described above, the optical head portion 10 including the objective lens 11 and the SIL 12 is mounted on the biaxial actuator (not shown), so that the tracking control circuit 23 controls the biaxial actuator based on the corrected tracking error signal to perform the tracking control.

Therefore, when the tracking control is to be performed, the tracking error signal with no offset is used, so that the accurate tracking control can be performed without depending on, for example, the radial runout of the optical disk. Similarly as in the conventional case, the gap servo circuit (not shown) controls the biaxial actuator (not shown) based on the gap error signal 26. Thus, the gap servo control is performed so as to make the interval between the SIL 12 and the optical disk 13 constant.

It is desirable to defocus the light beam incident on the two-divided photodetector (PD3) 25. Therefore, the position detection sensitivity for the optical head portion can be improved.

The optical head portion position signal 27 can be used for track jump. That is, by controlling the actuator using on the position signal, access to a desirable track is possible without always locating the actuator at a long distance from a neutral position in the case of track jump, so that it is unlikely to deteriorate the optical performance at the time of recording and reproduction.

According to the present invention, correction of the tracking error signal including the offset enables the light spot to be positioned at an accurate position relative to a track, even when the center of the SIL and the center of the objective lens are deviated from the center of the optical axis.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2006-156066, filed Jun. 5, 2006, which is hereby incorporated by reference herein in its entirety.

What is claimed is:

1. An optical information recording/reproduction apparatus for performing recording or reproduction of information, comprising:
an optical head portion including an objective lens and a solid immersion lens;
a laser light source, wherein the recording or reproduction of information is performed by focusing a light beam from the laser light source on an information recording medium through the optical head portion;
a first photodetector for detecting light reflected on the information recording medium, wherein a tracking error signal is generated from an output of the first photodetector; and
a second photodetector for detecting return light reflected on an end surface of the solid immersion lens which is opposed to the information recording medium, wherein a position signal of the optical head portion in a tracking direction is generated from an output of the second photodetector; and
a circuit for correcting the tracking error signal based on the position signal.

2. An optical information recording/reproduction apparatus according to claim 1, wherein the second photodetector is divided into two light-receiving regions in a direction parallel to a guide groove of the information recording medium, and the position signal is generated based on a difference between signals from the two divided light-receiving regions.
